(19) United States
(12) Patent Application Publication
(10) Pub. No.: US 2019/0154182 A1
(43) Pub. Date: May 23, 2019

(54) One piece pneumatic lockout device

(71) Applicant: Paul Edward Ponsegrau, Suring, WI (US)

(72) Inventor: Paul Edward Ponsegrau, Suring, WI (US)

(21) Appl. No.: 15/817,199

(22) Filed: Nov. 18, 2017

(51) Int. Cl. F16L 55/00

(52) U.S. Cl. CPC F16L 55/00

(57) ABSTRACT

A one piece pneumatic lockout device is disclosed. The key feature of the device is the shape and size of a hole located within a piece of sheet or plate material. One end of the hole is an opening large enough to be placed over the first ridge of a male pneumatic fitting. The remainder of the hole is a slot with parallel sides which is wide enough to fit over the diameter of the groove behind the ridge but not wide enough to fit over the ridge of the fitting. A locking device is then placed through the large opening, thus preventing the lockout device from being removed from the pneumatic fitting. With the lockout device in place on the male pneumatic fitting, it is then impossible to connect the fitting to a female supply fitting.

### BACKGROUND OF THE INVENTION

This invention is a one-piece safety lockout device intended to be used with a padlock to lock out and prevent the connection of compressed air to machinery that uses compressed air for an energy source.

### DESCRIPTION SUMMARY

The U.S. Occupational Health and Safety Administration (OSHA) requires machinery to be isolated and locked out from all sources of energy prior to service work, set-up work, or adjustments which may place the service technicians, operators or others at risk of injury. Compressed air is a common source of energy for machinery. It is common for machines which use compressed air to use male and female quick disconnect type couplings to connect to compressed air supply systems. Devices that lock over the male (inlet) fitting to prevent attachment of the female (supply) fitting are known in the safety lockout industry

One such device is disclosed in U.S. Pat. No. 6,997,420 B2 which is assigned to the Panduit Corporation. This device consists of two circular plates with 4 various sized slots to accept male pneumatic fittings and holes to accept a padlock. The user must ensure the proper sized slot is used for the particular fitting or the device would be ineffective. Another device is disclosed in U.S. Pat. No. 8,839,649 owned by Master Lock Company LLC. This device involves two interlocked sliding plates with a hook on one end that goes around the male pneumatic fitting and holes which will accept padlocks. The padlock needs to be in the proper hole to ensure a tight fit on the fitting. Another device is disclosed in U.S. Pat. No. 5,638,857 and is offered by Brady Worldwide. This device offers three sizes and styles of fittings that may be inserted and secured if the proper size padlock shackle is used. Some devices may not be effective using safety hasps in place of a padlock.

Problems associated with the pneumatic lockout devices currently available are as follows; they pose a higher risk of misuse or misapplication, such as, if the wrong opening or aperture is chosen, the lockout device will be able to be removed, thus allowing risk of injury. Most devices may be too large or shaped in such a manner as to prevent their use in close or confined spaces. Most devices are priced in a range that may limit their availability in the workplace. Technicians are less likely to use devices which are not readily available where needed.

Advantages of the disclosed one piece pneumatic lockout device over other types of pneumatic lockout devices disclosed in prior art are as follows: The pneumatic lockout device disclosed is one piece, economical and easy to manufacture, allowing for a low retail cost. This makes this device more likely to be readily available to the technician or operator requiring a method of locking out the compressed air source. The low cost of this device would allow for lockout devices to be located at each lockout point throughout a worksite, increasing the likelihood of compliance with plant safety procedures.

The pneumatic lockout device disclosed will function effectively with any size safety hasp device or padlock shackle diameter up to ⅜ inch (virtually any size of common padlock), making it more versatile than other pneumatic lockout devices. The pneumatic lockout device disclosed can be made smaller than other pneumatic lockout devices so as to allow its use in locations where other pneumatic lockout devices may be too large to fit. The pneumatic lockout device disclosed is simpler to use than other pneumatic lockout devices. There are no moving parts so the device cannot malfunction. The use of this device is extremely simple, with very little possibility of installation error.

The pneumatic lockout device disclosed will also fit a wider variety of male pneumatic fitting styles common in industry than most lockout devices currently available. The one piece pneumatic lockout device will work with Lincoln, Industrial, Aro, Schrader, Tru-flate and other popular pneumatic coupler/fitting styles.

### DESCRIPTION

The pneumatic lockout device disclosed is one piece with one or more key-hole type holes to accept both the male pneumatic fitting and the padlock or safety hasp. One end of the slotted hole is a larger diameter allowing it to fit over the end of the male pneumatic fitting. The remaining length of the slotted hole is a narrower width that slides over the groove of the fitting but will not allow the wider ridge portion of the fitting to slide through it. The principle feature of the one piece pneumatic lockout device is the shape of the hole. The outside size and shape of the device may vary to suit the manufacturer or end user. More than one lockout hole may be incorporated in each piece to accommodate different sized fittings. The piece may be sized to accommodate a logo, patent number, company name or other designation.

The disclosed pneumatic lockout device can be made of sheet material, preferably 0.090 inches to 1.200 inches in thickness, although the thickness may vary as long as it allows the device to slide in the slot of the male pneumatic fitting.

The disclosed pneumatic lockout device may be made of carbon steel, stainless steel, aluminum, hard plastic, composite or any other material hard enough to allow the device to maintain its shape when installed on the male pneumatic fitting.

The disclosed pneumatic lockout device may be produced by machining, molding, stamping, cutting, routing or any other suitable methods.

The disclosed one piece pneumatic lockout device may be colored by painting, anodization or other process. Preferable colors would increase visibility and help define the device as safety equipment.

The disclosed one piece pneumatic lockout device may also serve to prevent unauthorized use of pneumatic power tools and other such equipment by securing the device on the male fittings which are usually installed to the inlet ports.

A preferred method of manufacturing the disclosed one piece pneumatic lockout device would be as follows; stamp the pieces from 0.090 aluminum stock, deburr and remove any sharp edges, anodize or otherwise color the devices red and have the size of the device to lockout stamped in the material adjacent to the opening. As ¼ and ⅜ inch sizes comprise most of the coupling sizes commonly used in industry, a device could be made that incorporated both these size openings in one piece. The material around the opening could accommodate a company name or logo.

### BRIEF DESCRIPTION OF THE DRAWINGS

FIG. 1 illustrates a male pneumatic fitting aligned with the one piece pneumatic lockout device.

FIG. 2 illustrates the larger hole end of the one piece pneumatic lockout device positioned on the male pneumatic fitting.

FIG. 3 illustrates the slotted hole of the one piece pneumatic lockout device positioned about the groove of the male pneumatic fitting.

FIG. 4 illustrates the one piece pneumatic lockout device positioned on the male pneumatic fitting and secured by a padlock. This illustration should be used as the “front page drawing”.

FIG. 5 illustrates a schematic view of the configuration and parts of the hole in the one piece pneumatic lockout device.

FIG. 6 gives a perspective view of the configuration of the hole in the one piece pneumatic lockout device.

FIG. 7 illustrates a side view of a typical male pneumatic fitting indicating the shape and locations of the ridge and groove.

FIG. 8 illustrates a side view of a male pneumatic fitting aligned with a female pneumatic coupler in a position ready for connection.

FIG. 9 illustrates a side view of a male pneumatic fitting connected with a female pneumatic coupler allowing air flow through the connected devices.

FIG. 10 illustrates a side view of the one piece pneumatic lockout device secured to a male pneumatic fitting by a padlock and aligned with a female pneumatic coupler.

FIG. 11 illustrates a side view of the one piece pneumatic lockout device secured to a male pneumatic fitting by a padlock and a female pneumatic coupler placed on the male pneumatic fitting against the one piece pneumatic lockout device.

### DETAILED DESCRIPTION OF THE INVENTION

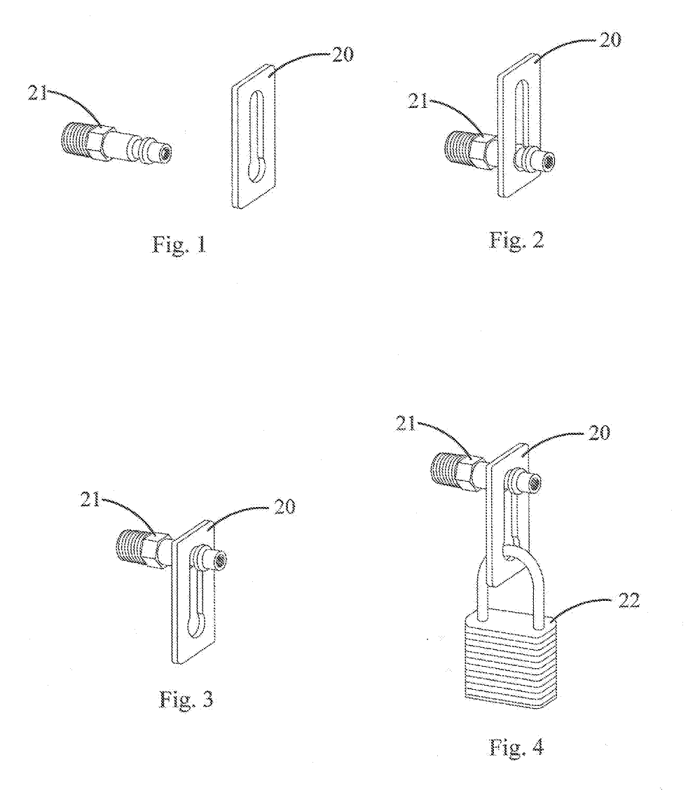

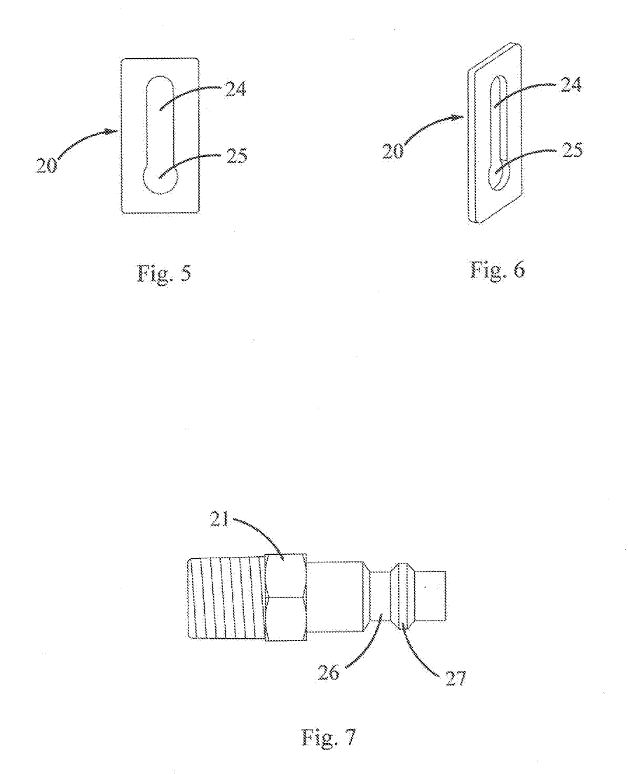

Referring to the drawing sheets and particularly FIG. 1, there is disclosed a one piece pneumatic lockout device, indicated by reference number 20, that is used to fit over a male pneumatic fitting indicated by reference number 21 in a manner to prevent a female pneumatic coupler 23 to be connected to the male pneumatic fitting. Referring to FIG. 5 and FIG. 7, the one piece pneumatic lockout device has a slotted hole 24 (FIG. 5) of at least ¾ inch in length having a hole 25 (FIG. 5) with a larger diameter than the width of the slotted hole at one end of the slotted hole. The width of the slotted hole is narrower than the diameter of the ridge 27 (FIG. 7) of the male pneumatic fitting, but wider than the diameter of the groove 26 (FIG. 7) of the male pneumatic fitting. The shape and configuration of the hole in the one piece pneumatic lockout device are further illustrated in FIG. 6.

The disclosed one piece pneumatic lockout device is used as follows: The large hole 25 (FIG. 5) is place over the ridge (FIG. 7) and about the groove 26 (FIG. 7) as shown in FIG. 2. The slotted hole 24 (FIG. 5) is moved along the groove 26 (FIG. 5) to the end of the groove as shown in FIG. 3. The groove 26 (FIG. 5) will not fit over the ridge 27 (FIG. 7) of the male pneumatic fitting 21, thereby preventing the removal of the one piece pneumatic lockout device 20. A padlock 22, safety hasp or other locking device is then inserted through the large hole 25 (FIG. 5) of the device, thereby preventing the removal of the device from the male pneumatic fitting 21 as illustrated in FIG. 4.

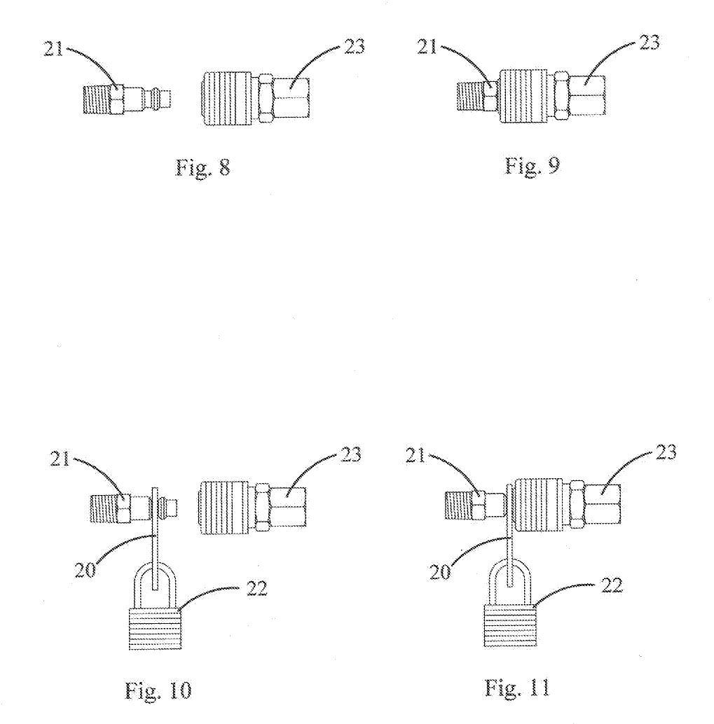

The effect of the one piece pneumatic lockout device is illustrated in FIG. 8, FIG. 9, FIG. 10 and FIG. 11. FIG. 8 illustrates a male pneumatic fitting 21 aligned with a female pneumatic coupler 23. FIG. 9 illustrates the female pneumatic coupler 23 in place over the male pneumatic fitting 21 allowing air flow from the coupler to the male fitting. FIG. 10 shows the one piece pneumatic lockout device 20 installed on the male pneumatic fitting 21 with a padlock 22 as previously described. FIG. 11 shows a pneumatic female coupler 23 placed on the male pneumatic fitting 21 with the one piece pneumatic lockout device 20 installed as in FIG. 10.

FIG. 11 illustrates that the pneumatic female coupler 23 cannot be placed in the connected position when the one piece pneumatic lockout device 20 is installed on the male pneumatic fitting 21.

What is claimed is:

1. A method of securing a male pneumatic fitting in a one piece pneumatic lockout device comprised of the following steps;
providing a piece of sheet, plate or other thin, flat material with at least one elongated hole within its interior.
the elongated hole will have a first end and a second end.
the first end of the elongated hole will be large enough to allow the ridge of a male pneumatic fitting to pass through up to and over the groove of the pneumatic fitting.
the remaining length of the elongated hole from the first end to the second end will have parallel sides and be wide enough to allow the groove of the male pneumatic fitting to pass freely to the second end but narrow enough that the ridge of the male pneumatic fitting cannot pass through the narrower second end of the elongated hole.
with the male pneumatic fitting positioned in the narrow second end of the elongated hole, a locking device is inserted though the first end of the elongated hole and locked, thus preventing the removal of the male pneumatic fitting from the one piece lockout device.
the first end of the elongated hole will be close enough to an outside edge of the sheet, plate, or other thin, flat material to allow a padlock, safety hasp ro other locking device to be secured through the hole.
the size of the first end of the elongated hole will be such that, with a locking device secured through the first end of the elongated hole, the male pneumatic fitting will no longer be able to be positioned so that the ridge of the male pneumatic fitting can pass through the first end of the elongated hole.
a male pneumatic fitting having a basic cylindrical shape and having a ridge and groove around its diameter to be retained by a female pneumatic fitting.

2. A one piece pneumatic lockout device comprised of;
a piece of sheet, plate, or other thin, flat material containing at least one elongated hole
wherein the elongated hole has a first end and a second end and;
the first end of the elongated hole will be large enough to allow the ridge of a male pneumatic fitting to pass through up to and over the groove of a male pneumatic fitting and;
the first end of the elongated hole will be close enough to at least one edge of the sheet, plate, or other thin, flat material to allow a padlock, hasp or other locking device to be secured through the first end of the elongated hole.
the remaining length of the elongated hole from the first end to the second end will have parallel sides and be wide enough to allow the groove of the male pneumatic fitting to pass freely to the second end but narrow enough that the ridge of the male pneumatic fitting cannot pass through the narrower second end of the elongated hole.

3. A one piece pneumatic lockout device according to claim 2 with a stamp, etching or other marking designating the size of pneumatic fitting the device is intended to lock out.

4. A method of securing a male pneumatic fitting with the one piece pneumatic lockout device according to claim 2 comprised of the following steps;
first, positioning a male pneumatic fitting having a basic cylindrical shape and having a ridge and groove around its diameter to be retained by a female pneumatic fitting, through the first end of the one piece pneumatic lockout device and;
second, positioning the male pneumatic fitting into the second end of the onepiece pneumatic lockout device and;
with the male pneumatic fitting positioned in the narrow second end of the elongated hole, a locking device is inserted though the first end of the elongated hole and locked, thus preventing the removal of the male pneumatic fitting from the one piece lockout device.

5. A one piece pneumatic lockout device according to claim 2 wherein the first end of the elongated hole has a circular shape with a diameter large enough allow the ridge of the male fitting to pass through.

6. A one piece pneumatic lockout device according to claim 2 which has a stamping, etching or other method of permanent marking which designates the size of the fittings that the one piece pneumatic lockout device is intended to lock out.

7. A method of securing a male pneumatic fitting in a one piece pneumatic lockout device comprised of the following steps;
providing a piece of sheet, plate or other thin, flat material with an elongated hole having one end large enough to fit over the ridge of the male pneumatic fitting and the remaining length of the elongated hole being narrower than the diameter of the ridge of the male pneumatic fitting and wider than the diameter of the groove of the male pneumatic fitting;
placing the first end of the hole over the ridge of the male pneumatic fitting perpendicular to the male pneumatic fitting and positioned over the groove of the male pneumatic fitting;
positioning the elongated hole along the groove of the male pneumatic fitting so that the male pneumatic fitting is in the narrower end of the elongated hole;
inserting a locking device or safety hasp through the wider end of the elongated hole so as to capture the fitting in the narrower portion of the elongated hole.
a male pneumatic fitting having a basic cylindrical shape and having a ridge and groove around its diameter to be retained by a female pneumatic fitting.

8. A one piece pneumatic lockout device comprising: a piece of sheet, plate or other flat, thin material containing an elongated hole having a first end and a second end, the first end being large enough to fit over the ridge of a male pneumatic quick connect fitting and the remainder of the elongated hole having parallel sides and a width narrower than the diameter of the ridge of the male pneumatic fitting and wider than the diameter of the fitting groove of the male pneumatic fitting so the first end of the elongated hole can be placed over the ridge of the a male pneumatic fitting and positioned over the fitting groove, then moved perpendicular to the male pneumatic fitting and then being secured by placing a locking device through the first end of the elongated hole.

9. An opening in sheet, plate, or other flat, thin material, the opening having a first end and a second end, the first end being large enough to allow the outer ridge diameter of a male pneumatic connector to pass through with only enough clearance to allow easy, no contact passage and which is close enough to an outside edge of the material to allow a padlock, hasp, lockout tag, or other device to be inserted through the first end, the second end of the opening having parallel sides and being wider than the groove of the male pneumatic fitting and narrower than the outer ridge diameter of the male pneumatic fitting so as to not allow the male pneumatic fitting to be removed through the second end of the opening and not be allowed to be positioned in the first end of the opening when a padlock, hasp, lockout tag or other device is inserted through the first end of the opening, thus securing the male pneumatic fitting in the opening.

10. A method of securing a male pneumatic connector fitting with a device having an opening as described in claim 9 comprised of the following steps. Step 1) The first end of the opening is placed over the male pneumatic fitting ridge. Step 2) The second end of the opening having parallel sides is positioned in the groove of the male pneumatic fitting. Step 3) A padlock, hasp, lockout tag or other type of device is then inserted through the first end of the opening preventing the removal of the device from the male pneumatic fitting and thus preventing the male pneumatic fitting from being connected to a compressed air supply.
